(19) United States
(12) Patent Application Publication
(10) Pub. No.: US 2023/0015166 A1
(43) Pub. Date: Jan. 19, 2023

(54) Online System That Facilitates Logging and Reversing Transactions

(71) Applicant: Q's Legacy, LLC, Nashville, TN (US)

(72) Inventors: Alexis Jones, Brentwood, TN (US); Ryane Elise Pamphile, Nashville, TN (US); Erwan Landreau Lent, Seattle, WA (US)

(21) Appl. No.: 17/375,257

(22) Filed: Jul. 14, 2021

(51) Int. Cl. G06Q 20/38; G06F 16/9535; G06F 9/54; G06F 16/2457; G06Q 30/06

(52) U.S. Cl. CPC G06Q 20/389; G06F 16/9535; G06F 9/54; G06F 16/24578; G06Q 30/0601

(57) ABSTRACT

An online system parses a data file from a third-party system to extract metadata of a transaction between a user and a source of an online system. The online system can receive the data file through various methods, such as using a browser plugin to review a webpage, retrieving an email from an email system that maintains an email account of the user, logging into the user's account with the source, or querying a system of the source (e.g., through API). Based on the metadata, the online system queries a database to identify the source of the online content item and retrieves a policy associated with the source. The online system determines a condition for reversing the transaction based on the metadata and the policy. The online system provides the metadata and condition to the user and allows the user to interact with the online system to reverse the transaction.

### BACKGROUND

This disclosure relates generally to transactions, and more specifically to logging and reversing transactions.

Electronic commerce allows people to buy goods or services from a seller over the Internet, e.g., by using a web browser or mobile app. Electronic commerce is getting more popular given the convenience of accessing different online sellers without visiting their bricks-and-mortar stores. Even though it is usually convenient to purchase goods online, it is not as convenient to return goods purchased online. It is hard for buyers to track online orders from different sellers. Also, different sellers have different return policies for online orders. Even the same seller can have different return policies for different goods. For example, there are sellers that charge buyers extra fees for returning online orders. There are also sellers that does not refund buyers for returned online orders. Currently available technology is mostly developed for improving online purchasing experience of buyers. However, the currently available technology fails to improve buyers' experience of tracking and returning online orders, especially for online orders from different sellers. Thus, improved technology for facilitating tracking and returning online orders is needed.

### SUMMARY

An online system facilitates logging and reversing online transactions. The online system receives, from third-party systems, data files associated with transactions between users of the online system and sources of online content items (also referred to as “sources”). The online system uses the data files to generate logs of transactions for the users. The online system provides a user interface to the users for the users to view the logs and to request reverse of transactions.

In some embodiments, the online system queries for information of a transaction between a user and a source of an online content item (e.g., an online vendor). The online system may query for the information by, e.g., using a browser plugin to review a webpage, retrieving an email from an email system that maintains an email account of the user, logging into the user's account with the source, querying a system of the source (e.g., by sending an API request), etc. The online system receives a data file from a third-party system, which may be a same system as the source or a different system. The data file may be an email message, a data package from the third-party system, a user account profile, a web page, a document, or some combination thereof. The online system parses the data file, e.g., by using a model specific to a category of the online content item, to extract metadata of the transaction. Metadata of a transaction is data providing information about the transaction, the corresponding online content item, and the corresponding source.

The online system uses the metadata to retrieve a policy of the source from a database that stores policies of a plurality of sources of online content item. For example, the online system uses the metadata to identify the source and retrieves the policy based on the identification of the source. The online system then determines a condition for reversing the transaction based on the retrieved policy and the metadata.

The online system generates a log for the user. The log includes the condition for reversing the transaction and at least some of the metadata. The online system provides the log for display to the user in a user interface running on a client device associated with the user. The user interface allows the user to interact with the online system to reverse the transaction. For instance, the user can request the online system to reverse the transaction on behalf of the user in the user interface.

The online system can query various third-party systems to receive data files associated with transactions performed by the user with various sources of online content items. The online system can combine the logs of a plurality of transactions of the user in the user interface. That way, the user can easily view and reverse his/her transactions with different sources in the user interface. Therefore, compared with the currently available technology, the online system provides a more advantage tool to improve user experience in managing and reversing online transactions.

### BRIEF DESCRIPTION OF THE DRAWINGS

FIG. 1 is a block diagram of a system environment in which an online system operates, in accordance with an embodiment.

FIG. 2 is a block diagram of an architecture of the online system, in accordance with an embodiment.

FIG. 3 is a block diagram of a transaction module, in accordance with an embodiment.

FIG. 4 illustrate a user interface for logs of transactions, in accordance with an embodiment.

FIG. 5 is a flow chart illustrating a method of logging and reversing a transaction between a user and a source of online content items, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

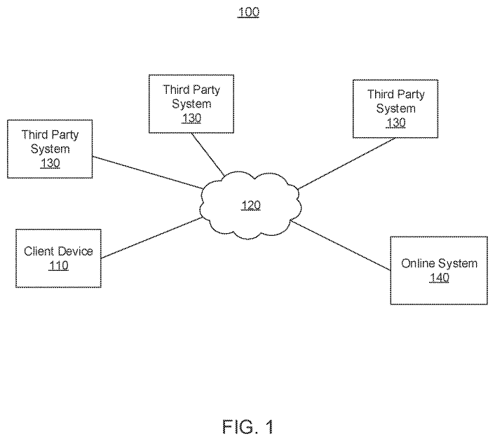

FIG. 1 is a block diagram of a system environment 100 in which an online system 140 operates, in accordance with an embodiment. The system environment 100 shown by FIG. 1 comprises a client device 110, a network 120, third-party systems 130, and the online system 140. In alternative configurations, different and/or additional components may be included in the system environment 100. For example, the system environment 100 may include more client devices or a different number of third-party systems 130.

The client device 110 is a computing device capable of receiving user input as well as transmitting and/or receiving data via the network 120. In one embodiment, the client device 110 is a conventional computer system, such as a desktop or a laptop computer. Alternatively, the client device 110 may be a device having computer functionality, such as a personal digital assistant (PDA), a mobile telephone, a smartphone, or another suitable device. The client device 110 is configured to communicate via the network 120. In one embodiment, the client device 110 executes an application allowing a user of the client device 110 to interact with the online system 140. For example, the client device 110 executes a browser application to enable interaction between the client device 110 and the online system 140 via the network 120. In another embodiment, the client device 110 interacts with the online system 140 through an application programming interface (API) running on a native operating system of the client device 110, such as IOS® or ANDROID™.

In some embodiments, the client device 110 executes an application provided by the online system 140 for facilitating communication between the online system 140 and the client device 110. For example, the client device 110 receives, from the online system 140, a transaction log generated by the online system 140 for the user. The application running on the client device 110 presents the transaction log to the user, e.g., through a display device coupled with or included in the client device 110. The application allows the user to interact with the log, e.g., submitting a request to converse a transaction in the log. The application sends the user's interaction to the online system 140 for the online system 140 to process the user's request. As another example, the client device 110 sends user account information of the user with a third-party system 130 to the online system 140 for the online system 140 to get information of transactions performed by the user from the third-party system 130.

In an embodiment, the client device 110 is an integrated computing device that operates as a standalone network-enabled device. For example, the client device 110 includes display, speakers, microphone, camera, and input device. In another embodiment, the client device 110 is a computing device for coupling to an external media device such as a television or other external display and/or audio output system. In this embodiment, the client device 110 may couple to the external media device via a wireless interface or wired interface (e.g., an HDMI cable) and may utilize various functions of the external media device such as its display, speakers, microphone, camera, and input devices. The client device 110 may be configured to be compatible with a generic external media device that does not have specialized software, firmware, or hardware specifically for interacting with the client device 110.

The client device 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

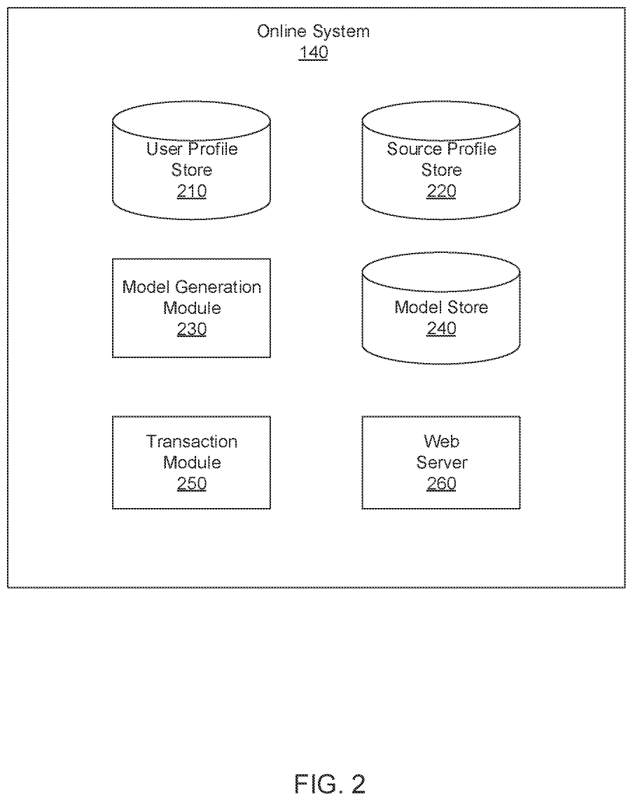

Third-party systems 130 (individually referred to as “third-party system 130”) are coupled to the network 120 for communicating with the client device 110 and the online system 140, which is further described below in conjunction with FIG. 2. The third-party systems 130 may also communicate with each other. Each of the third-party systems 130 may be a system providing online content items (such as an e-commerce website, an online source, etc.), a system providing communication service (e.g., an email service provider), or some combination thereof. For purpose of simplicity and illustration, FIG. 1 shows three third-party systems 130. In other embodiments, the system environment 100 includes more or fewer third-party systems 130.

In one example, a third-party system 130 is a source of online content item, such as an online source. The third-party system 130 communicates with the client device 110 through the network 120. The user of the client device 110 may interact with an online content item to perform a transaction with the third-party system 130. For instance, the user may purchase an online content item through the application executed on the client device 110. In some embodiments, the application is a browser application. In some other embodiments, the application is provided by the third-party system 130 for communicating data between the third-party system 130 and the client device 110. In some embodiments, the third-party system 130 maintains an account of the user. The third-party system 130 may also maintain a profile of the user that includes information associated with the user's interactions with the online content items provided by the third-party system 130.

In another example, a third-party system 130 is a communication service provider. It facilitates sending and receiving communications (e.g., emails, text messages, or other types of communications) between the client device 110 and other client devices. The third-party system 130 can also facilitate communications from another third-party system 130 (e.g., an online source) to the client device 110. For instance, a user, who performs a transaction with the online source, provides an email address maintained by the third-party system 130 to the online source. The online source sends emails associated with the transaction to the email address. The emails may include order confirmation, shipping notification, delivery notification, and so on. The third-party system 130 may protect security of the communications by requiring the user to set up a password for the email address.

A third-party system 130 communicates with the online system 140. For instance, the third-party system 130 receives from the online system 140 a query for information regarding a user's interaction with an online content item. In response to receiving the query, the third-party system 130 sends a data file associated with the user's interaction with the online content item to the online system 140. The data file may be an email message, a data package from the third-party system, a user account profile, a web page, a document, or some combination thereof. The query may include information associated with a user's account with the third-party system 130, such as an email address, a username, a password, etc. The third-party system 130 may allow the online system 140 to access the data file based on the information associated with the user's account, or the third-party system 130 sends the data file to the online system 140 after the third-party system 130 confirms the information associated with the user's account.

FIG. 2 is a block diagram of an architecture of the online system 140, in accordance with an embodiment. The online system 140 includes a user profile store 210, a source profile store 220, a model generation module 230, a model store 240, a transaction module 250, and a web server 260. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 210. A user profile includes transactions logs generated by the online system 140 for the user. A user profile in the user profile store 210 may also maintain references to actions by the corresponding user performed with transaction logs in the user profile. For instance, a user profile maintains references to requests made by the corresponding user to reverse transactions between the corresponding user and sources of online content items. The user profile includes information indicating status of the requests, such as information indicating: whether a request has been received by the online system 140, whether a request has been processed by the online system 140, whether a request has been forwarded to the corresponding source by the online system 140, whether the corresponding source has reversed the transaction, etc.

In some embodiments, a user profile also includes declarative information about the user that was explicitly shared by the user and may also include profile information inferred by the online system 140. For instance, a user profile includes authorization provided by the corresponding user to the online system 140 for the online system 140 to receive information related to transactions performed by the user from third-party systems. Examples of authorization includes information of the corresponding user's account with third-party systems, such as email address, username, password, etc.

A user profile may store other information provided by the corresponding online system user. For example, a user profile includes identifying information of the corresponding user, such as name, date of birth, image, and so on. certain embodiments, images of users may be tagged with information identifying the online system users displayed in an image, with information identifying the images in which a user is tagged stored in the user profile of the user. A user profile may also include contact information of the corresponding user, such as location, phone number, email address, and so on. A user profile may further include payment information, such as credit card numbers, banking information, and so on.

The source profile store 220 stores information of a plurality of sources of online content items. Each source of online content items has a source profile in the source profile store 220. A source profile includes one or more policies of the corresponding source. A policy of a source relates to one or more conditions for reversing a transaction that a user performed with the source. For instance, a policy of a source specifies at least one of the following: whether transactions with the source are reversible, time limits for reversing transactions with the source (e.g., 90 days from the transaction date), how to reverse transactions with the source (e.g., return to store or return by shipment), penalty for reversing transactions, whether reversed transactions are refundable, how much to be refunded for a reversed transaction, or some combination thereof. A source's policy can be shared by the source, such as information posted on a website of the source or information shared by the source with a user of the online system 140. A source's policy can also be inferred by the online system 140, for example, through transaction reverse processed by the online system 140. A source profile may also include descriptive information of the corresponding source, such as trade name, logo, mark, domain name, and so on.

The model generation module 230 generates parsing models to be used for parsing data files associated with transactions to extract metadata of the transactions. The parsing models are saved in the model store 240. A parsing model, when applied to a data file associated with a transaction, outputs information referring to metadata of the transaction. A parsing model may be specific to a particular source, e.g., a source associated with a source profile stored in the source profile store 220. The parsing model can be saved in the source profile store 220 as a part of the source profile.

In some embodiments, a parsing model includes a template for a source. The template describes configurations of data files associated with transactions between the source and users. Configurations of a data file include, e.g., layout, fonts, margins, styles, etc. The template, when applied to a new data file for the source, outputs information referring to metadata of the transaction associated with the new data file. In one embodiment, the model generation module 230 generates a template for a source based on data files for the source that are received by the online system 140 from third-party systems. The model generation module 230 may determine configurations that the data files for the sources have in common and generate the template based on the configurations. For instance, the model generation module 230 determines that the data files for a source each includes a table that includes an image of the corresponding online content item in a first column of the table, a name of the corresponding online content item in the second column of the table, and a price of the corresponding online content item in the third column of the table. Based on the determination, the model generation module 230 generates a template including a table that has a first column referring to image of online content item, a second column referring to name of online content item, and a third column referring to the price of online content item. In one embodiment, a source is associated with multiple types of data files, for instance, a source sends multiple emails to its customers for online transaction including email confirming placement of online transaction, email confirming shipment, email confirming delivery, etc. The model generation module 230 generates a template for each type of data file.

In some embodiments, the model generation module 230 applies machine learning techniques to generate a parsing model. As part of the generation of the model, the model generation module 230 forms a training set that includes a plurality of training data files and metadata extracted from each training data file. The model generation module 230 generates feature values from the training data files, the features being variables deemed potentially relevant to extracting metadata from data files. An ordered list of the features for a data file is herein referred to as the feature vector for the data file. In one embodiment, the model generation module 230 applies dimensionality reduction (e.g., via linear discriminant analysis (LDA), principle component analysis (PCA), or the like) to reduce the amount of data in the feature vectors for data files to a smaller, more representative set of data. The model generation module 230 uses supervised machine learning to train the parsing model, with the feature vectors of the training set as the inputs. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments.

In some embodiments, the model generation module 230 continuously trains a parsing model. For instance, the model generation module 230 communicates with the transaction module 250, which supports a user interface enabling the user to verify and/or edit metadata of transactions in logs presented to the user. The model generation module 230 generates a new training set that includes the metadata verified and/or edited by the user and the data file used to generate the corresponding log. The model generation module 230 uses the new training set to re-train the parsing model. The model generation module 230 continues to generate new training sets and re-train the parsing model as it receives more data from the user interface.

The transaction module 250 facilitates logging and reversing transactions between users and third-party systems. In some embodiments, the transaction module 250 sends a query to a third-party system for information regarding a user's interaction with an online content item. The interaction includes a transaction between the user and a source of the online content item. The third-party system may be a same system as the source of the online content item or a different system from the source. The transaction module 250 receives a data file from the third-party system in response to the query. The transaction module 250 parses the data file to extract metadata of the transaction. The metadata includes a description of the online content item (e.g., image, name, function, etc.), description of the source of the online content item (e.g., brand name, domain name, trademark, logo, image, etc.) description of the transaction (e.g., date, time, price, etc.), or some combination thereof.

The online system 250 uses the metadata to determine a condition for reversing the transaction. The online system 250 queries the source profile store 220 and uses the metadata to identify a source of the online content item and retrieves a policy associated with the source from the source profile store 220. The online system 250 applies the policy to the online content item to determine the condition for reversing the transaction. The transaction module 250 generates a log for the transaction, which includes the condition for reversing the transaction and at least some of the metadata. The transaction module 250 provides the log for display to the user in a user interface running on a client device associated with the user. The user interface allows the user to view the metadata included in the log and the condition for reversing the transaction. It also allows the user to interact with the transaction module 250 to reverse the transaction. For instance, the user may make a request for reversing the transaction by the transaction module 250 in the user interface.

The web server 260 links the online system 140 via the network 120 to the one or more client device 110, as well as to the one or more third-party systems 130. The web server 260 serves web pages, as well as other content, such as JAVA®, FLASH®, XML and so forth. The web server 260 may receive and route messages between the online system 140 and the client device 110, for example, instant messages, queued messages (e.g., email), text messages, short message service (SMS) messages, or messages sent using any other suitable messaging technique. A user may send a request to the web server 260 to upload information (e.g., images or videos) that are stored in the content store 210. Additionally, the web server 260 may provide application programming interface (API) functionality to send data directly to native client device operating systems, such as IOS®, ANDROID™, or BlackberryOS.

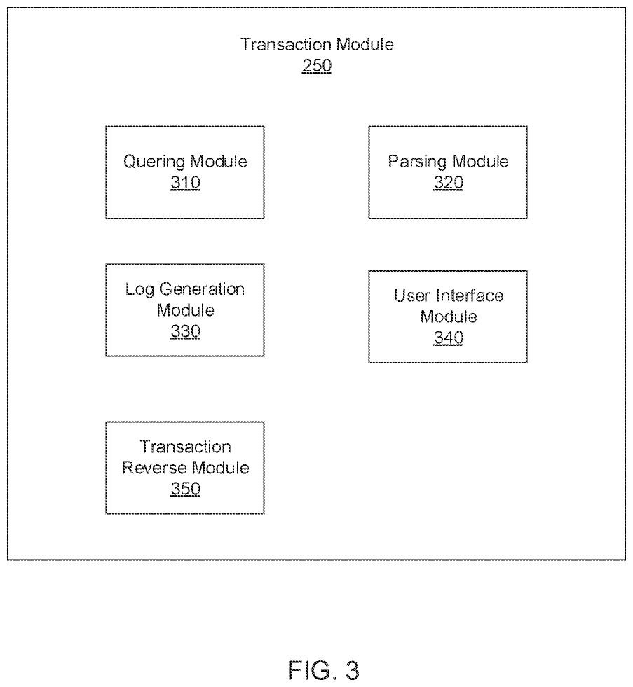

FIG. 3 is a block diagram of a transaction module 250, in accordance with an embodiment. The transaction module 250 generates a log of a transaction performed by the user and provide the log for display to the user in a user interface that allows the user to request reverse of the transaction. The transaction module 250 includes a querying module 310, a parsing module 320, a log generating module 330, a user interface module 340, and a transaction reverse model 350. In other embodiments, the transaction module 250 may include additional, fewer, or different components for various applications.

The querying module 310 queries for information regarding a user's interaction with an online content item. The user's interaction with the online content item includes a transaction between the user and a source of the online content item. In response to the querying, the querying module 310 receives from the third-part system a data file associated with the user's interaction with the online content item. The data file may be an email message, a data package from the third-party system, a user account profile, a web page, a document, or some combination thereof.

In some embodiments, the third-party system is an email service provider and the querying module 310 sends a request to the third-party system to access an email account of the user that is maintained by the third-party system. The querying module 310 may have received information of the user's email account from the user, including the user's email address and the user's password to the email account. The querying module 310 may include the information of the user's email account in the request to verify the user's authorization for the querying module 310 to request for information from the third-party system. After receiving the query, the third-party system sends a data file to the querying module. The data file may include one or more inbox emails in the user's email account with the third-party system. In one embodiment, the querying module 310 queries the third-party system at a predetermined frequency. For instance, the querying module 310 queries to the third-party system every day, every week, or at a different frequency. In another embodiment, the querying module 310 queries the third-party system in response to a request from the user. For instance, the user requests to update the logs of transactions performed by the user. In response to the user's request, the querying module 310 queries the third-party system.

In some other embodiments, the third-party system is a system of the source of the online content item, e.g., a system of an e-commerce source. The user performed the transaction through the third-party system, e.g., a website of the third-party system. The third-party system stores data associated with interactions performed by the user on the website. The querying module 310 sends an Applicant Programming Interface (API) request to the third-party system to access the data. The third-party system can send a data package to the querying module 310 that includes data describing the user's interactions with the third-party system, including the transaction. The data package may also include information about other actions perform by the user on the third-party system, including webpage viewing histories, advertisements that were engaged, and other patterns from shopping and buying referring to content items browsed by the user, etc. Additionally, actions a user performs via an application associated with the third-party system and executing on the client device of the user may be communicated to the querying module 310 by the application.

In some other embodiments, the querying module 310 queries a software program (e.g., a plug-in) in a web browser through which the user performed the interaction with the online content item. The software program can be provided by the online system and configured to track activities performed by the user through the web browser. For example, an e-commerce website may recognize a user of an online system 140 through a plug-in enabling the e-commerce website to identify the user of the online system 140. Because users of the online system 140 are uniquely identifiable, e-commerce websites, such as in the preceding example, may communicate, through the plug-in information about a user's actions outside of the online system 140 to the online system 140 for association with the user. Hence, the querying module 310 may receive, from the plug-in, information about actions users perform on the third-party system, including the transaction.

The parsing module 320 parses the data file from the third-party system to extract metadata of the transaction. The metadata provides information about the transaction, the online content item, and the source. Information about the transaction includes, for example, a time or date when the transaction was performed, a value associated with the transaction, and so on. Information about the online content item include information describing the online content item, such as image, name, function description, category, price, quantity, and so on. Information about the source include information identifying the source, such as trade name, domain name, image, logo, and so on.

In some embodiments, the parsing module 320 determines a category of the online content item based on the data file. The category, in one example, is the source of the online content item. For instance, the parsing module 320 identifies the source from the data file. The parsing module 320 then retrieves a parsing model that is specific to the source, e.g., from the model store 240. The parsing module 320 applies the parsing model to the data file and extracts the metadata of the transaction based on an output of the parsing model.

In one example, the parsing model, when applied to the data file, provides information referring to data in the data file. For example, the parsing model determines that a first image in the data file is an image of the online content item versus a second image in the data file is an image of the source, e.g., based on different locations, sizes, or other attributes of the two images in the data file. As another example, the parsing model determines that a text string in a particular location in the data file is the name of the online content item based on a font of the text string. The parsing module 320 extracts the metadata from the data file based on the output of the parsing model. In some embodiments, the parsing model includes a template specifying a configuration of the data file. In some other embodiments, the parsing model is a model trained with machine learning techniques for extracting metadata from data files. The parsing module 320 inputs the data file or a component of the data file to the parsing model, the parsing model outputs the metadata.

The parsing module 310 may determine that the metadata extract from the data file is insufficient, e.g., the data file does not include all the information describing the online content item. In response to the determination, the parsing module 320 requests the querying module 310 to query a different third-party system, e.g., the source of the online content item.

In some embodiments, multiple data files are received from the third-party system. The parsing module 310 may first screen the data files to select one or more of the data files. In one embodiment, the parsing module 310 parses the data files to determine a sequence in which the data files are generated and selects a data file based on the sequence and a policy of the source. For instance, the parsing module 310 determines that the data files include a first email message confirming placement of the transaction, a second email message confirming shipment of the goods related to the online content item, and a third email message confirming delivery of the goods. The parsing module 310 determines that the first email was generated first, then the second email was generated, and the third email was generated last. The parsing module 310 then selects the first email to extract metadata based on the policy of the source indicating that the first generated email includes more information about the transaction than subsequently generated emails. In another embodiment, the parsing module 310 compares content in the data files and determines that content of a first data file is included in a second data file. Based on such a determination, the parsing module 310 selects the second data file as the data file to extract metadata of the transaction. The parsing module 310 may remove the first data file to avoid duplication. In some embodiments, the parsing module 310 determines that each data file has different content and uses all the data files to extract metadata of the transaction.

The log generation module 330 generates a log of the user's interaction with the online content item. The log includes metadata extracted from the data file and a condition for reversing the transaction. The log generation module 330 determines the condition for reversing the transaction by using the metadata. For instance, the log generation module 330 queries the source profile store 220 to identify the source of the online content item based on identifying information of the source in the metadata. Then the log generation module 330 retrieves a policy associated with the source from the source profile store 220. The policy relates to conditions for reversing transactions between customers and the source. For instance, the policy specifies whether transactions with the sources are reversible, time limits for reversing transactions (e.g., 90 days from the transaction date), how to reverse transactions (e.g., return to store or return by shipment), penalty for reversing transactions, whether reversed transactions are refundable, how much to be refunded for a reversed transaction, or some combination thereof.

The log generation module 330 determines the condition for reversing the transaction by applying the policy to information about the transaction and/or the online content item in the metadata. In one example, the policy specifies that transactions are reversible if the transaction was made within 90 days. The metadata indicates that the transaction was performed 40 days ago. Based on the policy and metadata, the log generation module 330 determines that the transaction is reversible and that a condition to reverse the transaction is to request the reverse within 50 days. In another example, the policy specifies that transactions are reversible if the online content item is not for final sale. The metadata indicates that the online content item is for final sale. Based on the policy and metadata, the log generation module 330 determines that the transaction is not reversible.

In some embodiments, the log generation module 330 generates a plurality of logs, each of which is for a different transaction. The log generation module 330 may rank the logs based on a ranking score indicating an evaluation of potential reverse of the transaction. The log generation module 330 can determine a ranking score for a log by evaluating various factors, such as the a monetary value to be refunded to the user, form of refund, convenience of reversing the transaction, time needed for reversing the transaction, and so on. The log generation module 330 can evaluate the factors based on the metadata of the transaction and the condition to reverse the transaction. For instance, the log generation module 330 applies the condition to the metadata to determine a money amount the source would refund the user for the reverse of the transaction. The log generation module 330 determines the ranking score based on the money amount. The ranking score can be a number or text. The log generation module 330 may include the ranking score of a transaction in the corresponding log.

The log generation module 330 may classify the log into categories. In one embodiment, the log generation module 330 classifies the logs based on whether the corresponding transactions are reversible. For example, the log generation module 330 puts the logs of reversible transactions into a reverse group and put the logs of irreversible transactions into a non-reverse group. The log generation module 330 may further classify the logs of reversible transactions based on time limits for reversing the corresponding transactions. For instance, the transactions are grouped based on the deadline for reversing the transactions. Transactions, the reserve of which are due in a first time window (e.g., 5 days) are classified into in a first category includes transactions, versus transactions, reverse of which are due in a second time window (e.g., more than 5 days) are classified into a second category.

The user interface module 340 supports a user interface that presents logs generated by the log generation module 330. The user interface runs on a client device of the user, e.g., in a browser application or in an application provided by the online system 140. The user interface may display the logs in an order determined based on the ranking scores of the logs. The user interface may also display the logs based on the categories the logs are classified into. For instance, the user interface displays the categories and includes controls for enabling the user to select a category and review logs in that category. The user interface includes elements and controls for enabling user interactions with the logs. For instance, the user interface includes elements and controls that enable the user to edit the logs, such as removing a log, changing information in a log, changing the order the logs are listed, changing a category of a log, and so on.

The user interface module 340 also provides controls to enable the user to select a log and to request reverse the corresponding transaction. The user interface module 340 may provide controls to enable a user to specify a time for reversing the transaction. The user interface module 340 may provide controls to enable a user to request the transaction reverse module 350 to request the reverse with the source on the user's behalf.

The transaction reverse module 350 receives, through the user interface, a request to reverse a transaction and processes the reverse of the transaction in response to the request. In one example, the transaction reverse module 350 determines items required for reversing the transaction, such as the corresponding goods, receipts for the transaction, return slip from the source, etc. The transaction reverse module 350 forwards the request and the required items to a client device of a privileged user of the online system 140, which can proceed with requesting the reverse. In some embodiments, the transaction reverse module 350 determines status of the reverse request and provides the status for display in the user interface for the user to get updates of the progress of the reverse request.

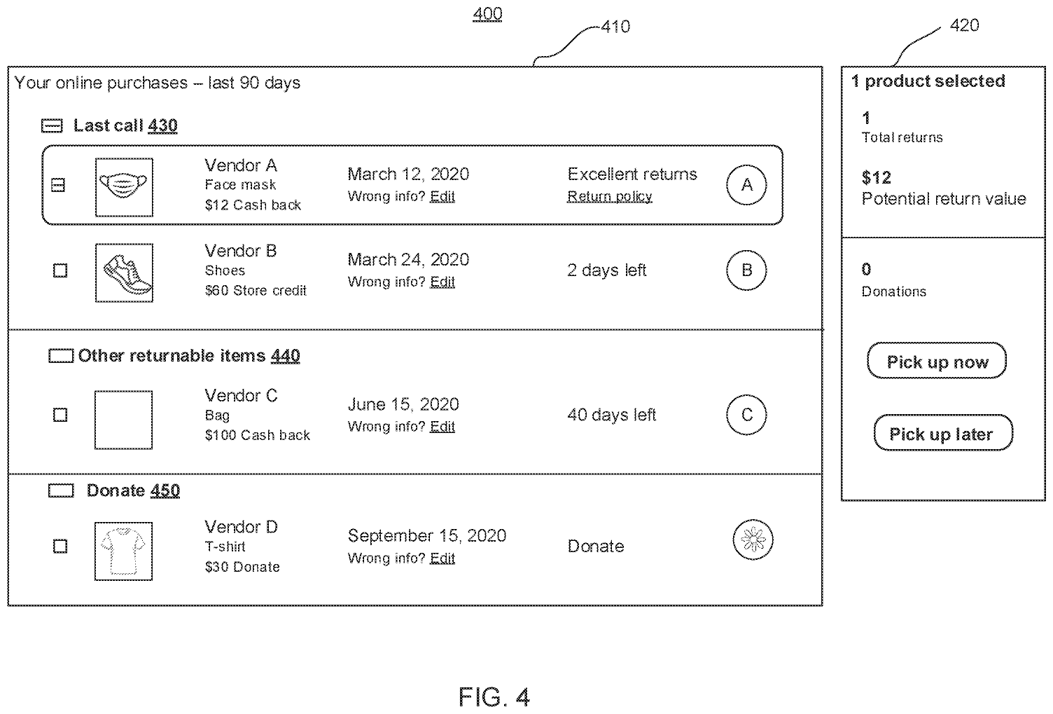

FIG. 4 illustrate a user interface 400 for logs of transactions, in accordance with an embodiment. The user interface 400 is supported by the user interface module 340 of the transaction module 250. The user interface 400 includes elements and controls enabling a user to view the logs and request reverse of the transactions. The user interface 400 is an example for illustration. In other embodiments, the user interface 400 includes different elements and controls.

The user interface 400 includes a log section 410 and a transaction reverse section 420. The log section 410 includes a list of logs. The log section 410 shows that the logs are for transactions made within the last 90 days. Each log corresponds to a different transaction and includes the following information: an image of the online content item, a name of the source, a name of the online content item, a monetary amount to be refunded to the user, form of refund (cash back or store credit), condition for reversing the transaction (e.g., whether it is excellent return), and logo of the source. The logs are displayed in three categories: “last call” category 430, “other returnable items” category 440, and “donate” category 450. The “last call” category 430 includes logs of two reversible transactions having reverse deadlines within a predetermined amount of time, e.g., 5 days. The “other returnable items” category 440 includes logs of other reversible transactions. The “donate” category 450 includes logs of irreversible transactions.

The log section 410 includes an “edit” button in each log for the user to edit information in the log, such as metadata of the transaction, if the user determines that the information is wrong. The log section 410 updates the log based on the user's edits. The user interface module 340 may send the updated log to other components of the online system 140, such as the model generation module 230, which can use the metadata of the transaction in the updated log to training parsing models. In embodiments where the user does not provide any edits, the user interface module 340 determines that the metadata of the transaction in the log is verified by the user. The user interface module 340 may send the verification to the model generation module 230, which can use the metadata of the transaction in the log to training parsing models.

The transaction reverse section 420 includes elements and controls enabling the user to request reverse of transactions. As shown in FIG. 4, the use has selected the first log in the “last call” category 430, indicated by the rectangular enclosing the first log. Upon the user's selection of the first log, the transaction reverse section 420 shows elements and controls related to reversing the transaction. In FIG. 4, the transaction reverse section 420 shows information about the reverse request, e.g., number of product, number of return, number of donation, and monetary amount for the return. The transaction reverse section 420 also shows controls enabling the user to select whether to pick up the product now or later.

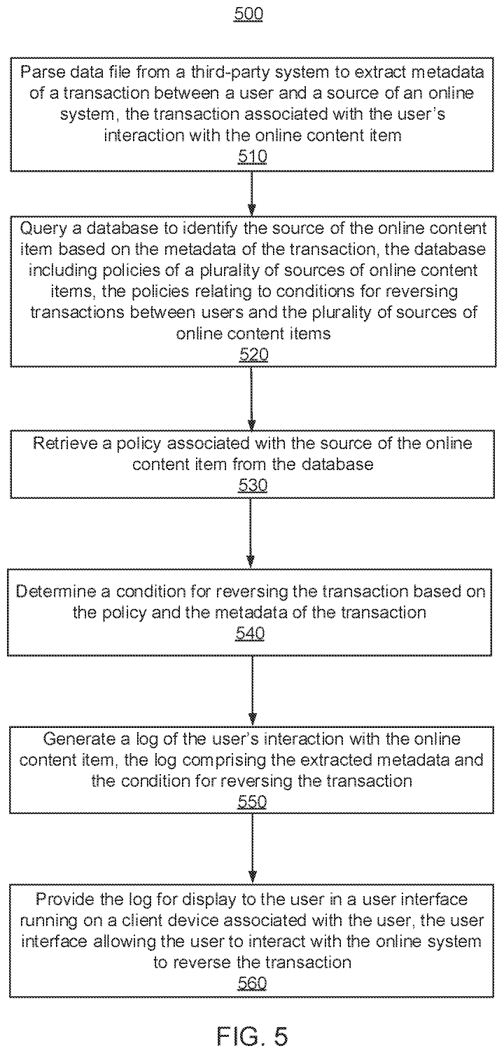

FIG. 5 is a flow chart illustrating a method of logging and reversing a transaction between a user and a source of online content items, in accordance with an embodiment. The method is performed by the transaction module 250 that is in communication with a third-party system and the source database 220.

The transaction module 250 parses 510 a data file from a third-party system to extract metadata of a transaction between a user and a source of an online system. The transaction is associated with the user's interaction with the online content item. The data file may be an email message, a data package from the third-party system, a user account profile, a web page, a document, or some combination thereof. In some embodiments, the transaction module 250 determines a category of the online content item based on the data file. The transaction module 250 applies a model that is specific to the category to the data file and extracts the metadata of the transaction based on an output of the model. In some embodiments (e.g., in embodiments where the source of the online content item is a different system from the third-party system), the transaction module 250 determines, based on a result of the parsing, that the data file does not include all the information describing the online content item. In response to the determination, the transaction module 250 queries the source of the online content item to obtain additional data.

In some embodiments, the transaction module 250 queries for the data file by using a software program (e.g., a browser plug-in) in a web browser through which the user performed the interaction with the online content item. The software program is provided by the online system and configured to track activities performed by the user through the web browser.

In some embodiments, the transaction module 250 queries the third-party system by sending a request to the third-party system to access an email account of the user that is maintained by the third-party system. For instance, the third-party system is a system that provides email service. The user's email account is supported and maintained by the third-party system. The user has provided the email account to the source of the online content item for performing the transaction, and the source of the online content item has sent emails associated with the transaction to the user's email account. The emails may be order confirmation, shipping notice, delivery notice, and so on. Such emails include information regarding the user's interaction with the online content item. The transaction module 250 retrieves an email message (i.e., the data file) associated with the transaction from the third-party system.

In some embodiments, the transaction module 250 queries the third-party system by sending a request for information of the user's account with the third-party system to the client device associated with the user. The transaction module 250 receives from the client device, the information of the user's account with the third-party system and accesses the user's account with the third-party system based on the received information to query for the information regarding the user's interaction with the online content item. For instance, the transaction module 250 requests for a username and password of the user's account with the third-party system. After receiving the username and password, the transaction module 250 logs into the user's account and access a profile of the user's account that is maintained by the third-party system.

In some embodiments, the transaction module 250 queries the third-party system for information regarding a user's interaction with an online content item. In one example, the transaction module 250 queries the third-party system by sending an Applicant Programming Interface (API) request to a third-party system to access data that is stored by the third-party system and associated with the user's interaction. The transaction module 250 receives the data file associated with the user's interaction with the online content item in response to the querying.

The transaction module 250 queries 520 a database to identify the source of the online content item based on the metadata of the transaction. The database stores policies of a plurality of sources of online content items. The policies relate to conditions for reversing transactions between users and the plurality of sources of online content items. The transaction module 250 retrieves 530 a policy associated with the source of the online content item from the database.

The transaction module 250 determines 540 a condition for reversing the transaction based on the policy and the metadata of the transaction. The condition may be associated with a time limit for reversing the transaction, return of the corresponding product, penalty for reversing the transaction, refund to the user, or some combination thereof. The transaction module 250 generates 550 a log of the user's interaction with the online content item. The log comprises the extracted metadata and the condition for reversing the transaction. In some embodiments, the transaction module 250 determines a ranking score of the online content item based on the policy associated with the source of the online system. The ranking score predicts a value of reversing the transaction. The transaction module 250 includes the ranking score in the log.

The transaction module 250 provides 560 the log for display to the user in a user interface running on a client device associated with the user. The user interface allows the user to interact with the online system to reverse the transaction.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method, comprising,
parsing, by an online system, a data file from a third-party system to extract metadata of a transaction between a user and a source of an online system, the transaction associated with the user's interaction with the online content item;
querying, by the online system, a database to identify the source of the online content item based on the metadata of the transaction, the database including policies of a plurality of sources of online content items, the policies relating to conditions for reversing transactions between users and the plurality of sources of online content items;
retrieving, by the online system, a policy associated with the source of the online content item from the database;
determining, by the online system, a condition for reversing the transaction based on the policy and the metadata of the transaction;
generating, by the online system, a log of the user's interaction with the online content item, the log comprising the extracted metadata and the condition for reversing the transaction; and
providing, by the online system, the log for display to the user in a user interface running on a client device associated with the user, the user interface allowing the user to interact with the online system to reverse the transaction.

2. The method of claim 1, further comprising:
querying for the data file by using a software program in a web browser through which the user performed the interaction with the online content item, the software program provided by the online system and configured to track activities performed by the user through the web browser.

3. The method of claim 1, wherein the third-party system is an email service provider and the data file is an email message retrieved from the third-party system.

4. The method of claim 1, further comprising:
sending, by the online system to the client device associated with the user, a request for information of the user's account with the third-party system;
receiving, by the online system from the client device, the information of the user's account with the third-party system; and
accessing the user's account with the third-party system based on the received information to retrieve the data file.

5. The method of claim 1, further comprising:
querying, by the online system, the third-party system for information regarding the user's interaction with the online content item; and
receiving, by the online system, the data file associated with the user's interaction with the online content item in response to the querying.

6. The method of claim 5, wherein querying, by the online system, the third-party system for the information regarding the user's interaction with the online content item comprises:
sending, by the online system, an Applicant Programming Interface (API) request to a third-party system to access data that is stored by the third-party system and associated with the user's interaction.

7. The method of claim 1, wherein parsing, by the online system, the data file received from the third-party system to extract the metadata of the transaction comprises:
determining a category of the online content item based on the data file;
obtaining a model that is specific to the category;
applying the model to the data file; and
extracting the metadata of the transaction based on an output of the model.

8. The method of claim 1, wherein the source of the online content item is a different system from the third-party system, and parsing, by the online system, the data file received from the third-party system to extract the metadata of the transaction comprises:
determining that the data file does not include all the information describing the online content item; and
in response to the determination, querying the source of the online content item to obtain additional data.

9. The method of claim 1, wherein generating, by the online system, the log of user's interaction with the online content item comprises:
determining a ranking score of the online content item based on the policy associated with the source of the online system, the ranking score predicting a value of reversing the transaction; and
including the ranking score of the online content item in the log.

10. The method of claim 1, further comprising:
receiving a plurality of data files from the third-party system in response to the querying, the plurality of data files including the data file and one or more other data files;
parsing the plurality of data files to identify a sequence in which the plurality of data files are generated; and
selecting the data file from the plurality of data files based on the sequence.

11. A non-transitory computer-readable memory storing executable computer program instructions, the instructions executable to perform operations comprising:
parsing, by an online system, a data file from a third-party system to extract metadata of a transaction between a user and a source of an online system, the transaction associated with the user's interaction with the online content item;
querying, by the online system, a database to identify the source of the online content item based on the metadata of the transaction, the database including policies of a plurality of sources of online content items, the policies relating to conditions for reversing transactions between users and the plurality of sources of online content items;
retrieving, by the online system, a policy associated with the source of the online content item from the database;
determining, by the online system, a condition for reversing the transaction based on the policy and the metadata of the transaction;
generating, by the online system, a log of the user's interaction with the online content item, the log comprising the extracted metadata and the condition for reversing the transaction; and
providing, by the online system, the log for display to the user in a user interface running on a client device associated with the user, the user interface allowing the user to interact with the online system to reverse the transaction.

12. The non-transitory computer-readable memory of claim 11, wherein the operations further comprise:
querying for the data file by using a software program in a web browser through which the user performed the interaction with the online content item, the software program provided by the online system and configured to track activities performed by the user through the web browser.

13. The non-transitory computer-readable memory of claim 11, wherein the third-party system is an email service provider and the data file is an email message retrieved from the third-party system.

14. The non-transitory computer-readable memory of claim 11, wherein the operations further comprise:
sending, by the online system to the client device associated with the user, a request for information of the user's account with the third-party system;
receiving, by the online system from the client device, the information of the user's account with the third-party system; and
accessing the user's account with the third-party system based on the received information to retrieve the data file.

15. The non-transitory computer-readable memory of claim 11, wherein the operations further comprise:
querying, by the online system, the third-party system for information regarding the user's interaction with the online content item; and
receiving, by the online system, the data file associated with the user's interaction with the online content item in response to the querying.

16. The non-transitory computer-readable memory of claim 15, wherein querying, by the online system, the third-party system for the information regarding the user's interaction with the online content item comprises:
sending, by the online system, an Applicant Programming Interface (API) request to a third-party system to access data that is stored by the third-party system and associated with the user's interaction.

17. The non-transitory computer-readable memory of claim 11, wherein parsing, by the online system, the data file received from the third-party system to extract the metadata of the transaction comprises:
determining a category of the online content item based on the data file;
obtaining a model that is specific to the category;
applying the model to the data file; and
extracting the metadata of the transaction based on an output of the model.

18. The non-transitory computer-readable memory of claim 11, wherein the source of the online content item is a different system from the third-party system, and parsing, by the online system, the data file received from the third-party system to extract the metadata of the transaction comprises:
determining that the data file does not include all the information describing the online content item; and
in response to the determination, querying the source of the online content item to obtain additional data.

19. The non-transitory computer-readable memory of claim 11, wherein generating, by the online system, the log of user's interaction with the online content item comprises:
determining a ranking score of the online content item based on the policy associated with the source of the online system, the ranking score predicting a value of reversing the transaction; and
including the ranking score of the online content item in the log.

20. The non-transitory computer-readable memory of claim 11, wherein the operations further comprise:
receiving a plurality of data files from the third-party system in response to the querying, the plurality of data files including the data file and one or more other data files;
parsing the plurality of data files to identify a sequence in which the plurality of data files are generated; and
selecting the data file from the plurality of data files based on the sequence.
